(19) United States
(12) Patent Application Publication
(10) Pub. No.: US 2012/0069600 A1
(43) Pub. Date: Mar. 22, 2012

(54) Double-Sided Light-Emitting Light Guide Plate Assembly and Method for Manufacturing the Same

(76) Inventors: YU-JENG LIN, Chungli City (TW); Chung-Lin Tsai, Chungli City (TW); Tsung-Yung Hung, Chungli City (TW)

(21) Appl. No.: 13/223,315

(22) Filed: Sep. 1, 2011

(30) Foreign Application Priority Data
Sep. 16, 2010 (TW) 099131443

(51) Int. Cl. F21V 13/02; B32B 37/16

(52) U.S. Cl. 362/616; 156/256; 156/306.6

(57) ABSTRACT

A double-sided light-emitting light guide plate assembly, and a method for manufacturing the same are disclosed, wherein a reflector is arranged between a first light guide plate and a second light guide plate. When light is emitted from a light source, it enters into the first light guide plate and the second light guide plate from one lateral side of the double-sided light-emitting light guide plate assembly. Through the reflector having two opposite reflective surface, the light is output from the first light output surface of the first light guide plate, and the second light output surface of the second light guide plate, such that the light guide plate assembly of the present invention can emit light from its two opposite surfaces.

### BACKGROUND OF THE INVENTION

1. Field of the Invention

The present invention relates a double-sided light-emitting light guide plate assembly, and a method for manufacturing the same.

2. The Prior Arts

Light sources generally can be divided into the direct light sources and the indirect light sources. A light emitting unit such as a light bulb or a lamp tube that directly emits light is defined as a direct light source. Light obtained by using a light conducting component to direct light from the light source is defined as an indirect light source. Generally speaking, the direct light source has a relatively high brightness, and is usually used for illumination, but the direct light source such as LEDs can also be used for the decoration. But for a large area, a large number of LEDs have to be installed, and the light emitted from these LEDs is too dazzling. The brightness of indirect light source is relatively low and soft, and usually used for decoration, indication, or used in a backlight module which can use a small number of light sources to illuminate a large area.

The light conducting component for the indirect light source includes an optical fiber or a light guide plate. The optical fiber spreads the light in one dimension, and thereby the light guide plate is often used as the light conducting component to spread the light in more than one dimension. For example, a backlight module for a liquid crystal television, a display, or an advertisement billboard, etc. includes a light guide plate, and a light source. For a thin electronic product, the LED used as the light source is disposed at a lateral side of the light guide plate, and a reflector is disposed on one surface of the light guide plate, and the optical sheets such as diffusion sheet, and prism sheet can be optionally disposed on another surface of the light guide plate, and a frame is provided for enclosing the above-mentioned components. When the light emitted by the light source enters into the light guide plate from the lateral side thereof, a part of the light is reflected by the reflector, and passed through the light output surface of the light guide plate, and subsequently passed through the diffusion sheet, and the prism lens sheet so as to be emitted out.

For maintaining the stability of light guiding, the light guide plate usually has good rigidity, and has a plane shape, so that it can be only used in a flat panel display. If the light guide plate is desired to be used in a non-planar (e.g. a curved plane or corrugated plane, etc.) device, a large number of light guide plates having small areas are assembled to form the desired curved plane. Therefore, the manufacturing process is complicated and the production cost is high, and the assembled curved plane is not smooth.

The applicant of Taiwan Patent Application No. 98123947 tried to solve the above-mentioned problems, in which at least one light source is installed in at least one side of a flexible light guide plate or the interior of the light guide plate, and the flexible light guide plate is fitted and fixed to the contour of a non-planar object, and the light emitted from the light source will enter the light guide plate, so that the non-planar object can emit light. However, in Taiwan Patent Application No. 98123947, the light can only be emitted from one surface of the light guide plate, and can not be emitted from the two surfaces of the light guide plate.

### SUMMARY OF THE INVENTION

The objective of the present invention is to provide a double-sided light-emitting light guide plate assembly which is able to emit light from the two surfaces thereof, and a method for manufacturing the same.

The double-sided light-emitting light guide plate assembly of the present invention comprises a first light guide plate, a second light guide plate, and a reflector disposed between the first light guide plate and the second light guide plate. When the light is emitted from a light source, it enters into the first light guide plate and the second light guide plate from one lateral side of the double-sided light-emitting light guide plate assembly. Through the reflector having two opposite reflective surface, the light is able to output from the first light output surface of the first light guide plate, and the second light output surface of the second light guide plate, such that the light guide plate assembly of the present invention can emit light from its two surfaces.

According to one aspect of the present invention, all of the light guide plates and the reflector are flexible so that the double-sided light-emitting light guide plate assembly of the present invention is flexible.

According to another aspect of the present invention, all of the light guide plates and the reflector are rigid, or one of the light guide plates and the reflector is flexible so that the double-sided light-emitting light guide plate assembly of the present invention is rigid.

According to the first aspect of the method for manufacturing a double-sided light-emitting light guide plate assembly of the present invention, the first flexible and reeled light guide plate and the second flexible and reeled light guide plate are provided, and the first flexible light guide plate and the second flexible light guide plate are respectively continually delivered. In this method, the first flexible light guide plate is continually delivered, and during the delivery of the first flexible light guide, one surface of the flexible reflector is bonded to the first flexible light guide plate, and then the bonded first flexible light guide plate is continually delivered, and during the delivery of the bonded first flexible light guide, the second flexible light guide plate is continually bonded to another surface of the flexible reflector so that the first flexible light guide plate, the flexible reflector, and the second flexible light guide plate are bonded together.

According to the second aspect of the method for manufacturing a double-sided light-emitting light guide plate assembly of the present invention, the first flexible and reeled light guide plate and the second flexible and reeled light guide plate are provided, and the first flexible light guide plate and the second flexible light guide plate are respectively continually delivered. In this method, the first flexible and reeled light guide plate and the second flexible and reeled light guide plate are provided. In this method, the first flexible light guide plate is unreeled and continually delivered to the first position, and then one surface of the flexible reflector is bonded to the first flexible light guide plate, and then the first flexible light guide plate is continually delivered to the second position, and then the second flexible light guide plate is unreeled and bonded to another surface of the flexible reflector so that the first flexible light guide plate, the flexible reflector, and the second flexible light guide plate are bonded together.

According to the third aspect of the method for manufacturing a double-sided light-emitting light guide plate assembly of the present invention, the first flexible light guide plate and the second flexible light guide plate are respectively delivered to its predetermined position, and respectively cut into a predetermined size, and then the flexible reflector is arranged between the cut first flexible light guide plate and the cut second flexible light guide plate so that the first flexible light guide plate, the flexible reflector, and the second flexible light guide plate are bonded together.

According to the method of the present invention, the reflector can be a reflective film or a reflective coating layer.

According to the present invention, the reflector is a reflective film having one reflective surface or two reflective surfaces.

According to the present invention, the reflector has at least one surface which has a continuously or a non-continuously distributed reflective area used for reflecting light.

According to the fourth aspect of the method for manufacturing a double-sided light-emitting light guide plate assembly of the present invention, the first rigid light guide plate, the rigid reflector, and the second rigid light guide plate are provided. In this method, during the delivery of the first rigid light guide, one surface of the rigid reflector is bonded to the first rigid light guide plate, and then the bonded first rigid light guide plate is continually delivered, and during the delivery of the bonded first rigid light guide plate is continually delivered, the second rigid light guide plate is continually bonded to another surface of the rigid reflector so that the first rigid light guide plate, the rigid reflector, and the second rigid light guide plate are bonded together.

According to the fifth aspect of the method for manufacturing a double-sided light-emitting light guide plate assembly of the present invention, one of the first light guide plate, the reflector, and the second light guide plate are flexible.

According to the fifth aspect of the method for manufacturing a double-sided light-emitting light guide plate assembly of the present invention, the first flexible or rigid light guide plate and the second flexible or rigid light guide plate are respectively delivered to its own predetermined position, and respectively cut into a predetermined size, and then the flexible or rigid reflector is arranged between the cut first light guide plate and the cut second light guide plate so that the first light guide plate, the reflector, and the second light guide plate are bonded together.

The method for manufacturing a double-sided light-emitting light guide plate assembly of the present invention further comprises providing a positioning device, and a capturing device, wherein the positioning device is used to position the light guide plates, and the capturing device is used to capture a portion of the light-emitting light guide plates, which is enclosed by the positioning device.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing the double-sided light-emitting light guide plate assembly according to the first embodiment of the present invention;

FIG. 2 is a schematic view showing the double-sided light-emitting light guide plate assembly according to the second embodiment of the present invention;

FIG. 3 is a schematic view showing the method for manufacturing the double-sided light-emitting light guide plate assembly according to the first embodiment of the present invention;

FIG. 4 is a schematic view showing the method for manufacturing the double-sided light-emitting light guide plate assembly according to the second embodiment of the present invention;

FIGS. 5A to 5C are schematic views showing the method for manufacturing the double-sided light-emitting light guide plate assembly according to the third embodiment of the present invention;

FIGS. 6A to 6C are schematic views showing the method for manufacturing the double-sided light-emitting light guide plate assembly according to the fourth embodiment of the present invention;

FIGS. 7A to 7C are schematic views showing the method for manufacturing the double-sided light-emitting light guide plate assembly according to the fifth embodiment of the present invention;

FIG. 8A shows a continuously distributed reflective area on a surface of a reflector according to one embodiment of the present invention;

FIG. 8B shows a non-continuously distributed reflective area on a surface of a reflector according to another embodiment of the present invention;

FIG. 9A is a schematic view showing a positioning device, and a capturing device provided in the method for manufacturing the double-sided light-emitting light guide plate according to one embodiment of the present invention; and

FIG. 9B is a schematic view showing that the positioning is used to position the light guide plates and the reflectors, and the capturing device is used to separate out a portion of the light guide plate assembly according to one embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

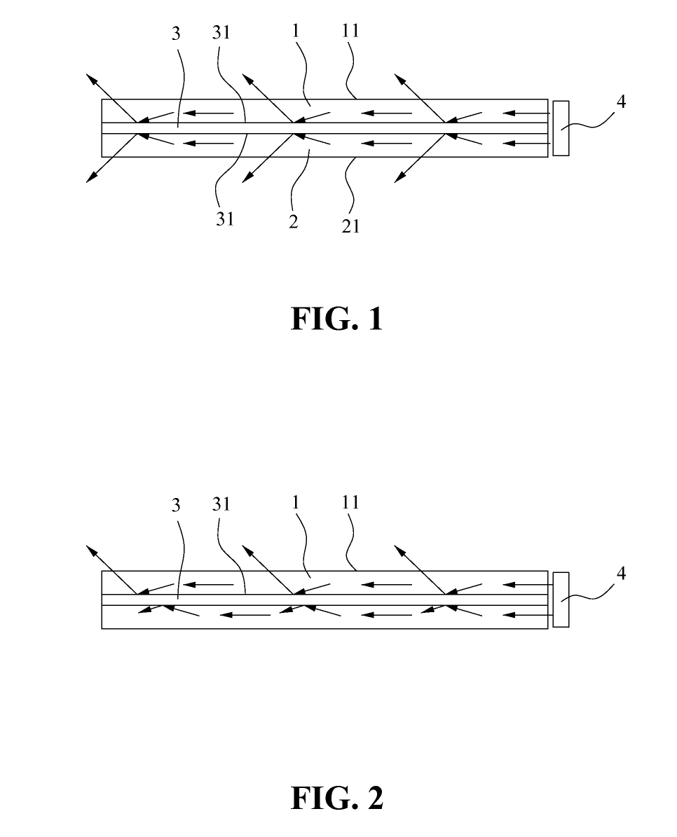

FIG. 1 is a schematic view showing the double-sided light-emitting light guide plate assembly according to the first embodiment of the present invention. The light guide plate assembly includes a first light guide plate 1, a second light guide plate, and a reflector 3 disposed between the first light guide plate 1 and the second light guide plate 2. A light source 4 is installed at one lateral side of the light guide plate assembly including the first light guide plate 1, the second light guide plate 2, and the reflector 3. LED is preferably used as the light source 4. The light is emitted from the light source 4, and then enters into the first light guide plate 1 and the second light guide plate 2. Through the reflector 3 having two opposite reflective surface 31, the light is output from a first light output surface 11 of the first light guide plate 1, and a second light output surface 21 of the second light guide plate 2, such that the light guide plate assembly can emit light from its two surfaces. The light guide plate assembly of the present invention can be used in, for example, the advertisement billboard, the display, or the indication plate, which has two light-transmittable surfaces. As shown in FIG. 2, the reflector 3 can have one surface 31 with enhanced reflection property, and have another surface with its own reflection property but without any enhancement. The light guide plate assembly having one surface with enhanced reflection property can be used in, for example, a computer display, a liquid crystal display, or an advertisement billboard, which has a single light-transmittable surface. According to one embodiment of the present invention, the first light guide plate 1 and the second light guide plate 2 can be a flexible plate, or a rigid plate. The reflector 3 can be a flexible reflector, a rigid reflector, or a reflective coating.

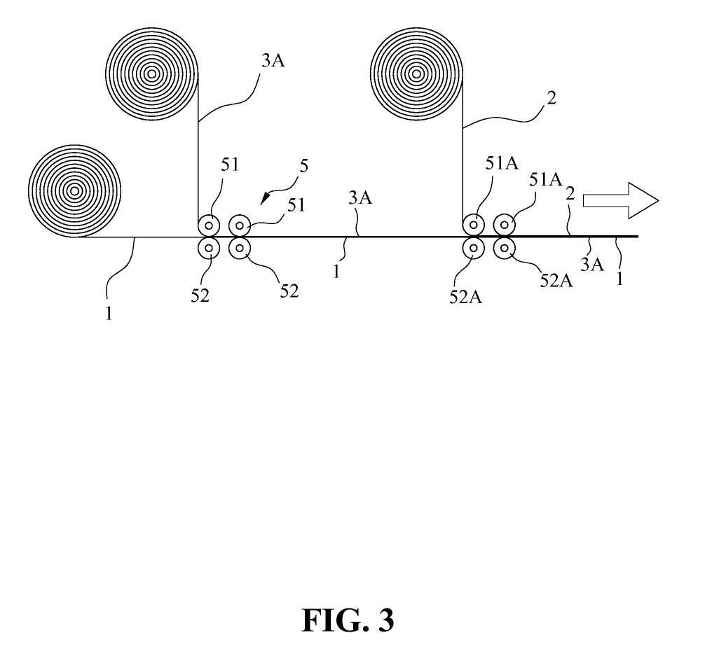

FIG. 3 shows a method for manufacturing the double-sided light-emitting light guide plate assembly according to the first embodiment of the present invention. The first flexible and reeled light guide plate 1 is wound around a first winder, and the second flexible and reeled light guide plate 2 is wound around a second winder, and the flexible and reeled reflector 3A is wound around a third winder. The first flexible light guide plate 1 and the flexible reflector 3A are respectively unreeled from the first and the third winders, and are stacked together and passed between the top rollers 51 and the bottom rollers 52 of the delivering and pressing machine 5, which exert considerable pressure, wherein the top rollers 51 and the bottom rollers 52 are driven to rotate by a power system, wherein the top rollers 51 and the bottom rollers 52 are installed with the heating device (not shown in figures). When the first flexible light guide plate 1 and the flexible reflector 3A are passed between the top rollers 51 and the bottom rollers 52 of the delivering and pressing machine 5, they are heated, pressed, and bonded together. Then, the first flexible light guide plate 1 bonded with the flexible reflector 3A are continuously delivered to a predetermined position by the delivering and pressing machine 5. Subsequently, the second flexible light guide plate 2 is unreeled from the second winder and stacked on the surface of the flexible reflector 3A bonded to the first flexible light guide plate 1 during passing the first flexible light guide plate 1 bonded with the flexible reflector 3A through another set of the top rollers 51A and the bottom rollers 52A which are connected to the power system, wherein the top rollers 51A and the bottom rollers 52A are also installed with heating devices (not shown in the figures). After stacked, the second flexible light guide plate 2, and the flexible reflector 3A bonded with the first flexible light guide plate 1 are heated, pressed, and bonded together to form the double-sided light-emitting light guide plate assembly. Then, the formed double-sided light-emitting light guide plate assembly is cut into a predetermined size according to the desired specification.

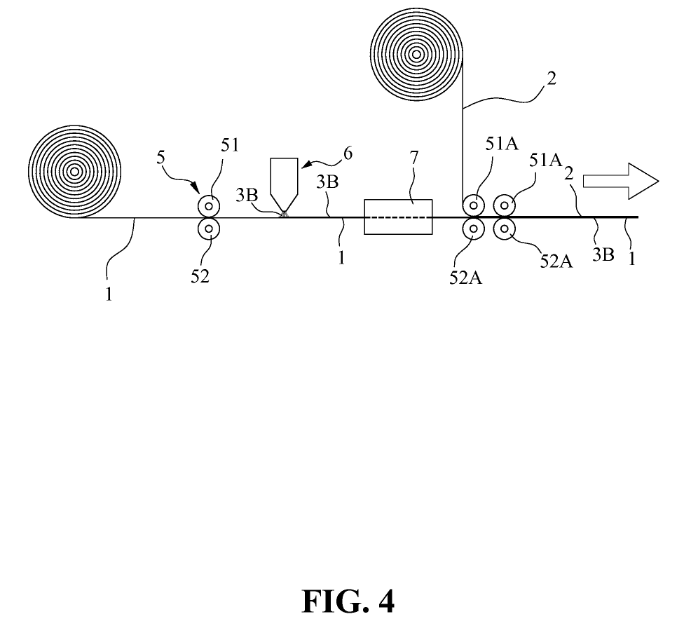

FIG. 4 shows a method for manufacturing the double-sided light-emitting light guide plate assembly according to the second embodiment of the present invention. The first flexible and reeled light guide plate 1 is wound around a first winder, and the second flexible and reeled light guide plate 2 is wound around a second winder. The first flexible light guide plate 1 is unreeled from the first winder, and is passed between the top rollers 51 and the bottom rollers 52 of the delivering and pressing machine 5, wherein the top rollers 51 and the bottom rollers 52 are driven to rotate by a power system. Then, the first flexible light guide plate 1 is continuously delivered by the delivering and pressing machine 5, and during the delivery of the first flexible light guide plate 1, a liquid light reflecting material 3B is coated on the first flexible light guide plate 1 by using a coating device 6. Then, the coated first flexible light guide plate 1 is continuously delivered and passed through the drying device 7 to allow the liquid light reflecting material 3B coated on the first flexible light guide plate 1 to dry, so that the liquid light reflecting material 3B can be bonded to the first flexible light guide plate 1. Then, the first flexible light guide plate 1 bonded with the light reflecting material 3B is continuously delivered to a predetermined position by the delivering and pressing machine 5. Subsequently, the second flexible light guide plate 2 is unreeled from the second winder and stacked on the surface of the light reflecting material 3B bonded to the first flexible light guide plate 1 during passing the first flexible light guide plate 1 bonded with the light reflecting material 3B through another set of the top rollers 51A and the bottom rollers 52A which are connected to the power system, wherein the top rollers 51A and the bottom rollers 52A are installed with heating devices (not shown in the figures). After stacked, the second flexible light guide plate 2, and the light reflecting material 3B, bonded with the first flexible light guide plate 1 are heated, pressed, and bonded together to form the double-sided light-emitting light guide plate assembly. Then, the formed double-sided light-emitting light guide plate assembly is cut into a predetermined size according to the desired specification.

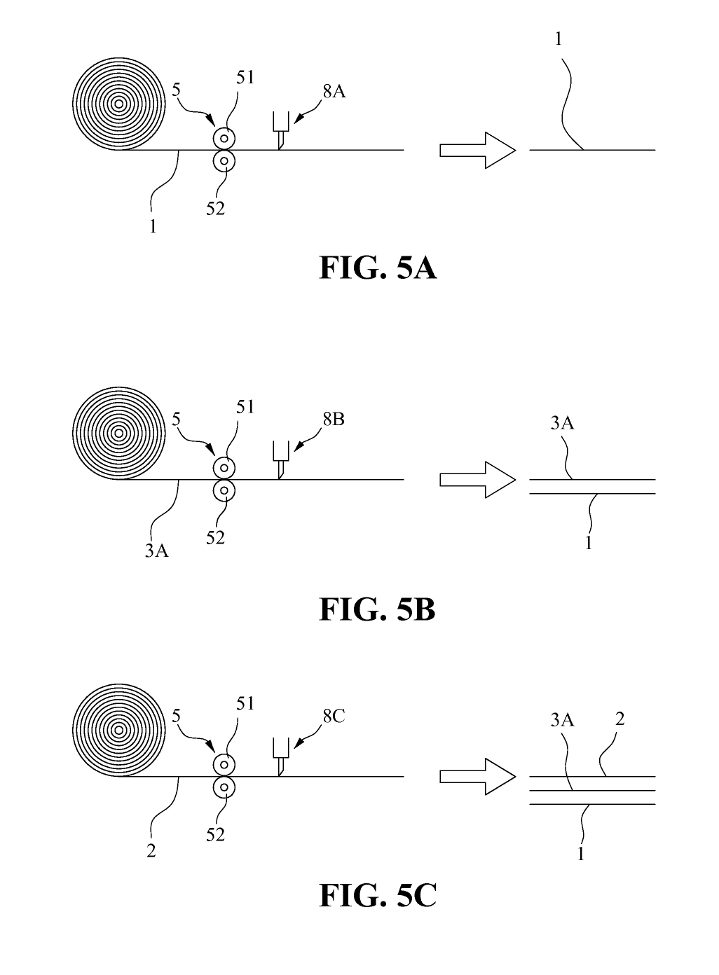

FIG. 5A to FIG. 5C show a method for manufacturing the double-sided light-emitting light guide plate assembly according to the third embodiment of the present invention. The first flexible and reeled light guide plate 1 is wound around a first winder, and the second flexible and reeled light guide plate 2 is wound around a second winder, and the flexible and reeled light reflecting film 3A is wound around a third winder. Referring to FIG. 5A, the first flexible light guide plate 1 is unreeled from the first winder, and is passed between the top rollers 51 and the bottom rollers 52 of the delivering and pressing machine 5, wherein the top rollers 51 and the bottom rollers 52 are driven to rotate by a power system. Then, the first flexible light guide plate 1 is continuously delivered to a predetermined position by the delivering and pressing machine 5, and then it is cut into a predetermined size according to the desired specification by using a cutting device 8A. Referring to FIG. 5B, the flexible light reflecting film 3A is unreeled from the third winder, and is passed between the top rollers 51 and the bottom rollers 52 of the delivering and pressing machine 5, wherein the top rollers 51 and the bottom rollers 52 are driven to rotate by a power system. Then, the light reflecting film 3A is continuously delivered to a predetermined position by the delivering and pressing machine 5, and then it is cut into a predetermined size according to the desired specification by using a cutting device 8B. Then, the cut light reflecting film 3A is moved by a mechanism (e.g. a mechanical arm incorporated with a vacuum suction disc) (not shown in the figures) and stacked on the cut first flexible light guide plate 1, and then the cut light reflecting film 3A is moved by a mechanism (e.g. a mechanical arm incorporated with a vacuum suction disc) (not shown in the figures) and stacked on the cut first flexible light guide plate 1. After stacked, the cut light reflecting film 3A and the cut first flexible light guide plate 1 are heated, pressed, and bonded together by a pressing device (not shown in the figures). Referring to FIG. 5C, the second flexible light guide plate 2 is unreeled from the second winder, and is passed between the top rollers 51 and the bottom rollers 52 of the delivering and pressing machine 5, wherein the top rollers 51 and the bottom rollers 52 are driven to rotate by a power system. Then, the second flexible light guide plate 2 is continuously delivered to a predetermined position by the delivering and pressing machine 5, and then it is cut into a predetermined size according to the desired specification by using a cutting device 8C. Then, the cut second flexible light guide plate 2 is moved by a mechanism (e.g. a mechanical arm incorporated with a vacuum suction disc) (not shown in the figures) and stacked on the surface of the cut light reflecting film 3A bonded with the cut first flexible light guide plate 1. After stacked, the cut second flexible light guide plate 2, and the cut light reflecting film 3A bonded with the cut first flexible light guide plate 1 are heated, pressed, and bonded together by a pressing device (not shown in the figures) so that the light reflecting film 3A is bonded between the first flexible light guide plate 1 and the second flexible light guide plate 2.

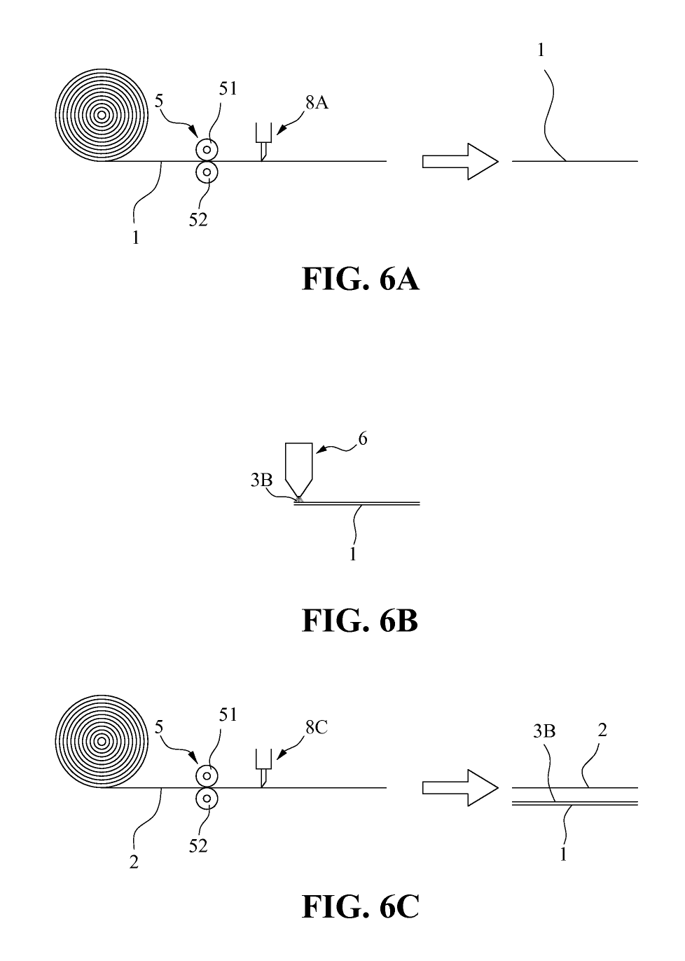

FIG. 6A to FIG. 6C show a method for manufacturing the double-sided light-emitting light guide plate assembly according to the fourth embodiment of the present invention. The first flexible and reeled light guide plate 1 is wound around a first winder, and the second flexible and reeled light guide plate 2 is wound around a second winder, and a coating device 6 capable of applying a light reflecting material 3B to the substrate. Referring to FIG. 6A, the first flexible light guide plate 1 is unreeled from the first winder, and is passed between the top rollers 51 and the bottom rollers 52 of the delivering and pressing machine 5, wherein the top rollers 51 and the bottom rollers 52 are driven to rotate by a power system. Then, the first flexible light guide plate 1 is continuously delivered to a predetermined position by the delivering and pressing machine 5, and then it is cut into a predetermined size according to the desired specification by using a cutting device 8A. Referring to FIG. 6B, when the cut first flexible light guide plate 1 is delivered to another predetermined position, a liquid light reflecting material 3B is coated on the first flexible light guide plate 1 by using a coating device 6. Then, the coated first flexible light guide plate 1 is delivered and passed through a drying device (not shown in the figures) to allow the liquid light reflecting material 3B coated on the first flexible light guide plate 1 to dry, so that the light reflecting material 3B can be bonded to the first flexible light guide plate 1. Referring to FIG. 6C, the second flexible light guide plate 2 is unreeled from the second winder, and is passed between the top rollers 51 and the bottom rollers 52 of the delivering and pressing machine 5, wherein the top rollers 51 and the bottom rollers 52 are driven to rotate by a power system. Then, the second flexible light guide plate 2 is continuously delivered to a predetermined position by the delivering and pressing machine 5, and then it is cut into a predetermined size according to the desired specification by using a cutting device 8C. Then, the cut second flexible light guide plate 2 is moved by a mechanism (e.g. a mechanical arm incorporated with a vacuum suction disc) (not shown in the figures) and stacked on the surface of the light reflecting material 3B bonded to the cut first flexible light guide plate 1. After stacked, the cut second flexible light guide plate 2, and the light reflecting material 3B bonded to the cut first flexible light guide plate 1 are heated, pressed, so that the light reflecting material 3B is bonded between the first flexible light guide plate 1 and the second flexible light guide plate 2.

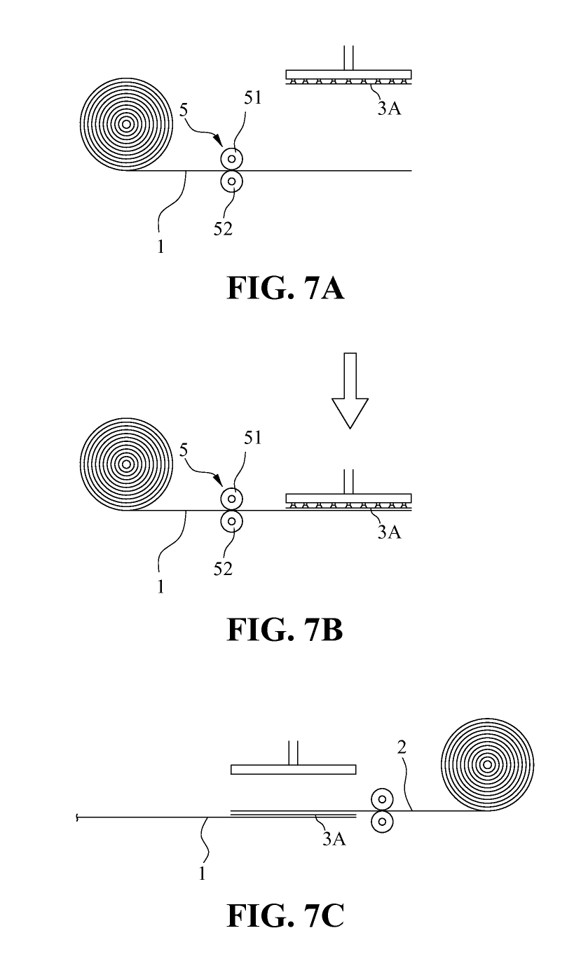

FIG. 7A to FIG. 7C show a method for manufacturing the double-sided light-emitting light guide plate assembly according to the fifth embodiment of the present invention. The first flexible and reeled light guide plate 1 is wound around a first winder, and the second flexible and reeled light guide plate 2 is wound around a second winder, and a flexible light reflecting film 3A is provided. Referring to FIG. 7A, the first flexible light guide plate 1 is unreeled from the first winder, and is passed between the top rollers 51 and the bottom rollers 52 of the delivering and pressing machine 5, wherein the top rollers 51 and the bottom rollers 52 are driven to rotate by a power system. Then, the first flexible light guide plate 1 is continuously delivered to a first position by the delivering and pressing machine 5 and stops at the first position. Referring to FIG. 7B, the light reflecting film 3A, which is cut into a predetermined size according to the desired specification, is stacked on the first flexible light guide plate 1. After stacked, the cut light reflecting film 3A and the first flexible light guide plate 1 are heated, pressed, and bonded together by a pressing device (not shown in the figures). Referring to FIG. 7C, the first flexible light guide plate 1 bonded to the cut light reflecting film 3A is then delivered to a second position and stops at the second position. Then, the second flexible light guide plate 2 is unreeled from the second winder and stacked on the surface of the light reflecting film 3A. After stacked, the second flexible light guide plate 2, and the cut light reflecting film 3A bonded to the first flexible light guide plate 1 are heated, pressed, and bonded together by a pressing device (not shown in the figures) so that the light reflecting film 3A is bonded between the first flexible light guide plate 1 and the second flexible light guide plate 2 to form the double-sided light-emitting light guide plate assembly. Then, the double-sided light-emitting light guide plate assembly is cut into a predetermined size according to the desired specification.

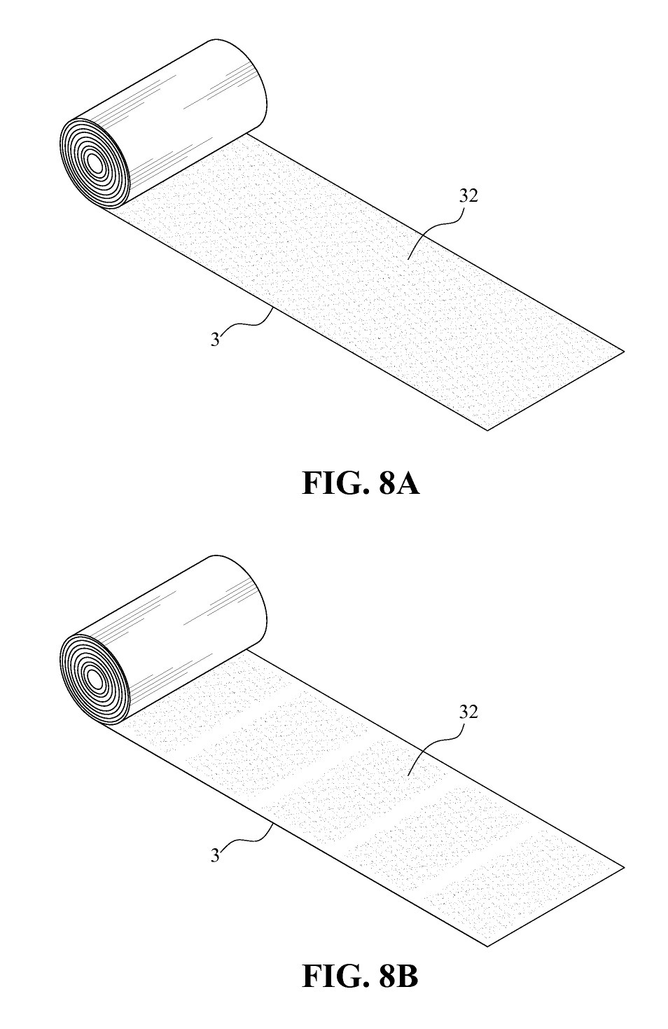

FIG. 8A shows a continuously distributed reflective area 32 on the surface of a reflector 3. FIG. 8B shows a non-continuously distributed reflective area 32 on the surface of the reflector 3. The non-continuously distributed reflective area means that the reflective area is arranged in a non-continuous way on the surface of the reflector 3. This reflector 3 is suitable to be delivered to a predetermined position, and then is cut into a predetermined size, and then is moved by a mechanism and stacked on the first light guide plate 1 or the second light guide plate 2. After stacked, the reflector 3, and the first flexible light guide plate 1 or the second light guide plate 2 are heated, pressed, and bonded together.

In the manufacture of the rigid double-sided light-emitting light guide plate assembly of the present invention, a rigid first light guide plate and a rigid second light guide plate are provided, and then a reflector is arranged between the rigid first light guide plate and the rigid second light guide plate, and subsequently the reflector, the rigid first light guide plate, and the rigid second light guide plate are heated, pressed, and bonded together. Alternatively, a liquid light reflecting material is coated on the surface of the rigid first light guide plate, and followed by drying so that the light reflecting material can be bonded to the first flexible light guide plate. Then, the rigid second light guide plate is stacked on the surface of the light reflecting material coating layer bonded to the rigid first light guide plate 1. After stacked, the rigid second light guide plate, and the light reflecting material coating layer bonded to the rigid first light guide plate 1 are heated, pressed, and bonded together, so that the light reflecting material coating layer is bonded between the first rigid light guide plate and the second rigid light guide plate.

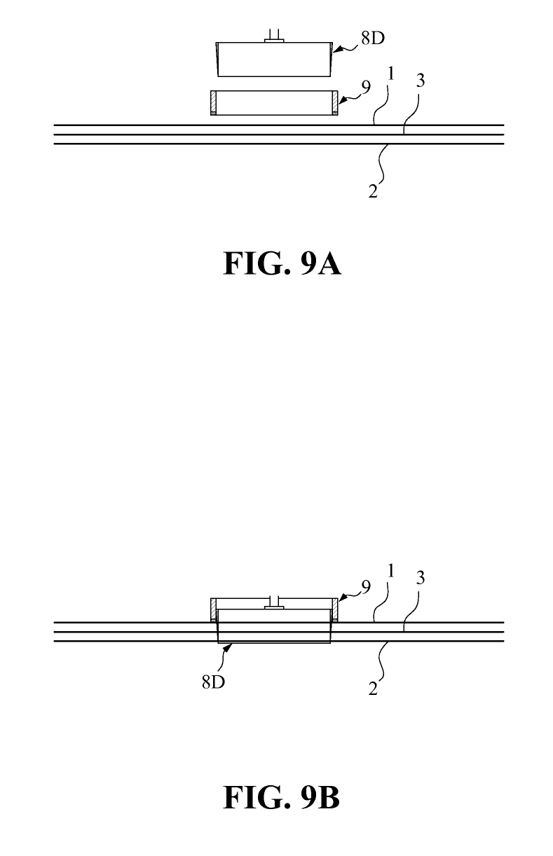

For economical consideration, a large-sized first light guide plate, second light guide plate, and reflector are firstly heated, pressed, and bonded together to form a large-sized double-sided light-emitting light guide plate assembly, then the large-sized double-sided light-emitting light guide plate assembly is punched, milled, or cut into a predetermined size. As shown in FIG. 9, in one embodiment of the present invention, at least one positioning device 9 and a capturing device 8D are provided. The positioning device 9 is used to exactly position a large-sized first light guide plate, second light guide plate, and reflector which are placed at the predetermined position, and subsequently the large-sized first light guide plate, second light guide plate, and reflector are bonded together to form a large-sized double-sided light-emitting light guide plate assembly, and then a section of the large-sized double-sided light-emitting light guide plate assembly is punched, milled, or cut into a predetermined size by a capturing device 8D. The positioning device 9 can be an enclosed frame, and have a soft pad installed at its lower part, wherein the soft pad can be in contact with the light guide plate assembly. When the light guide plate assembly is delivered to a predetermined position, the positioning device 9 is descended to position the light guide plate assembly. The positioning device 9 can be in any device as long as it is capable of positioning the light guide plate assembly.

According to the present invention, the capturing device 8D can be a punching mold, a milling device, a laser cutting device, or any other devices capable of cutting the light guide plate assembly. As shown in FIG. 9B, After the positioning device 9 is descended to position the light guide plate assembly, the capturing device 8D is descended to separate out a portion of the light guide plate assembly, which is enclosed by the positioning device 9, so that a relatively small or medium-sized light guide plate assembly can be obtained.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A double-sided light-emitting light guide plate assembly, comprising:
a first light guide plate;
a second light guide plate; and
a reflector disposed between the first light guide plate and the second light guide plate.

2. The light guide plate assembly according to claim 1, wherein all of the first light guide plate, the second light guide plate, and the reflector are flexible.

3. The light guide plate assembly according to claim 1, wherein one of the first light guide plate, the second light guide plate, and the reflector is flexible.

4. The light guide plate assembly according to claim 1, wherein the reflector has at least one surface having a continuously or a non-continuously distributed reflective area used for reflecting light.

5. The light guide plate assembly according to claim 1, wherein the reflector is a reflective coating layer.

6. A method for manufacturing a double-sided light-emitting light guide plate assembly, comprising:
providing a first light guide plate, a second light guide plate, and a reflector, a reflector being arranged between the first light guide plate and the second light guide plate.

7. The method for manufacturing the light guide plate assembly according to claim 6, wherein the first light guide plate and the second light guide plate are respectively cut into a predetermined size, and the reflector is arranged between the cut first light guide plate and the cut second light guide plate.

8. The method for manufacturing the light guide plate assembly according to claim 7, wherein the reflector has at least one surface having a continuously or a non-continuously distributed reflective area used for reflecting light.

9. The method for manufacturing the light guide plate assembly according to claim 7, further comprising providing at least one positioning device, and a capturing device, wherein the positioning device is used to position the first light guide plate, the second light guide plate, and the reflector at one predetermined position, and then the first light guide plate, the second light guide plate, and the reflector are bonded together to form the double-sided light-emitting light guide plate assembly, and the capturing device is used to separate out a portion of the double-sided light-emitting light guide plate assembly.

10. The method for manufacturing the light guide plate assembly according to claim 9, wherein the capturing device includes a punching mold, a milling device, or a laser cutting device.

11. The method for manufacturing the light guide plate assembly according to claim 6, wherein all of the first light guide plate, the second light guide plate, and the reflector are flexible.

12. The method for manufacturing the light guide plate assembly according to claim 6, wherein one of the first light guide plate, the second light guide plate, and the reflector is flexible.

13. The method for manufacturing the light guide plate assembly according to claim 6, wherein the reflector is a reflective coating layer.
